(19) United States
(12) Patent Application Publication
(10) Pub. No.: US 2006/0062414 A1
(43) Pub. Date: Mar. 23, 2006

(54) Loudspeaker rotary mechanism attached to a display

(76) Inventors: Chih-Wei Yeh, Padeh City (TW); Cheng-Kuang Mi, Padeh City (TW); Fu-Yun Teng, Padeh City (TW); Yii-Hong Wu, Padeh City (TW)

Correspondence Address: BIRCH STEWART KOLASCH & BIRCH, PO BOX 747, FALLS CHURCH, VA, 22040-0747, US

(21) Appl. No.: 10/944,187

(22) Filed: Sep. 20, 2004

(51) Int. Cl. H04R 9/06; H04R 5/02; H04R 1/02

(52) U.S. Cl. 381/333; 381/306; 381/388

(57) ABSTRACT

The invention provides a loudspeaker mounting mechanism capable of adjusting the loudspeaker angle for generating stereo surrounding sound effect, or meeting personal sound effect favorites. By means of hinge links the loudspeaker to the display in a manner that the loudspeaker can be rotated relatively to the display, instead of being fixed as conventional attached loudspeakers.

### BACKGROUND OF THE INVENTION

1. Field of the Invention

The invention generally relates to a loudspeaker rotary mechanism applicable to a display, and in particular relates to a loudspeaker mechanism capable of adjusting the mounting angle.

2. Description of the Related Art

Attachable loudspeakers of prior arts are mainly of fixed types. The loudspeaker is fixedly hung on sides of the display. Even if the loudspeaker can be adjusted, it is limited to a specific angle, inconvenient to use or poor in sound effect.

Moreover, televisions nowadays emphasize much on their audio effects. The conventional fixedly mounted loudspeaker is unable to satisfy user's requirements on the sound quality. Therefore, the invention intends to provide a pivotally mounted loudspeaker that can be freely adjusted by user in suitable angles so as to suit the user's needs for better sound quality.

### SUMMARY OF THE INVENTION

The object of the invention is to solve the problem of conventional fixedly mounted loudspeaker and provide a loudspeaker mounting mechanism that can be adjusted with the angles to produce a better sound field.

The invention relates to a loudspeaker mechanism capable of adjusting the mounting angle for generating stereo surrounding sound effect.

The loudspeaker is mounted outside a display, through a rotary mechanism. The rotary mechanism hangs the loudspeaker onto the display through a hinge. The hinge makes the loudspeaker adjustable with its angles for building different stereo sound effects, and solving the problem of conventional stationary loudspeakers.

### BRIEF DESCRIPTION OF THE DRAWINGS

The invention will become more fully understood from the detailed description given herein below. However, this description is for purposes of illustration only, and thus is not limitative of the invention, wherein:

FIG. 1 is a top view of a rotary loudspeaker connected to a display in a first embodiment of the invention;

FIG. 2 is a perspective view of a hinge used in a loudspeaker rotary mechanism of the invention;

FIGS. 3A, 3B, and 3C are perspective, sectional, and plane views of a Belleville spring used in the hinge of a loudspeaker rotary mechanism of the invention;

FIG. 4 is a top view of a rotary loudspeaker of the invention being rotated backward with a θ angle relatively to the display;

FIG. 5 is a top view of a rotary loudspeaker connected to a display in a second embodiment of the invention; and

FIG. 6 is a top view of a rotary loudspeaker of the invention being rotated forward with a p angle relatively to the display.

### DESCRIPTION OF THE PREFERRED EMBODIMENTS

Televisions nowadays focus not only on their image quality, but also their sound effects. From a physical view, sound transmission depends on the sound wave and the media. The sound effect of a loudspeaker is not only influenced by the box volume and the material quality, but also the direction and angle that it faces to.

Similar to the angle of view of a display, the sound effect of a loudspeaker is also relative to its angle to build the better stereo surrounding sound effect. The novel design of the invention allows the user changing the angle of the suspended loudspeakers and obtaining the required sound effects.

### First Embodiment

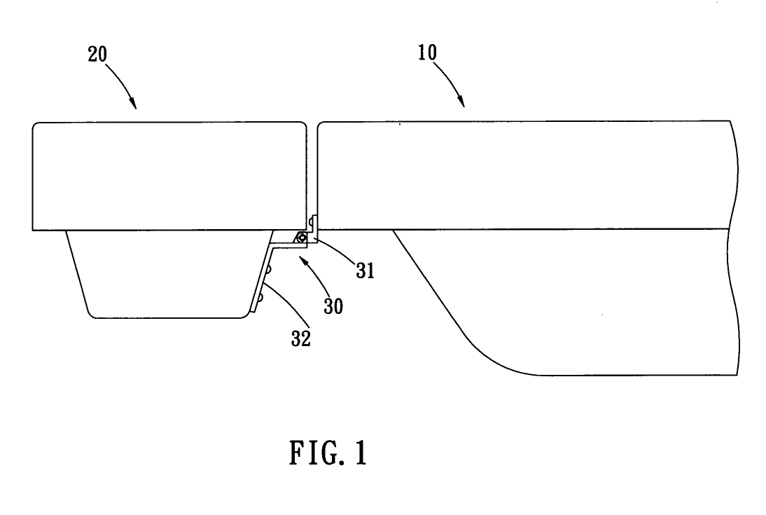

An embodiment of the invention is applied to a display. As shown in FIG. 1, a first embodiment of the invention. A loudspeaker rotary mechanism comprises a display 10, at least an attachable loudspeaker 20, and a rotary mechanism. The rotary mechanism is a hinge 30 which composed of two members 31 and 32. Said first member 31 connects with an axle and a second member 32 without an axle. Said first member 31 connects with a side of said display 10 and said second member 32 connects with a side of said attachable loudspeaker 20. Said hinge 30 links said loudspeaker 20 to said display 10 in a manner that said loudspeaker 20 can be rotated relatively to said display 10.

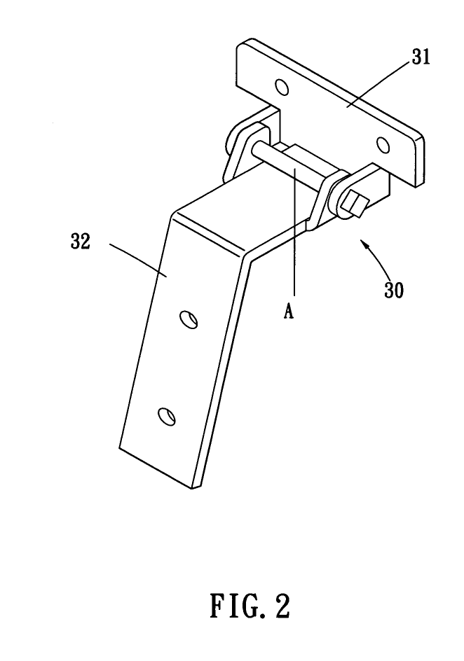

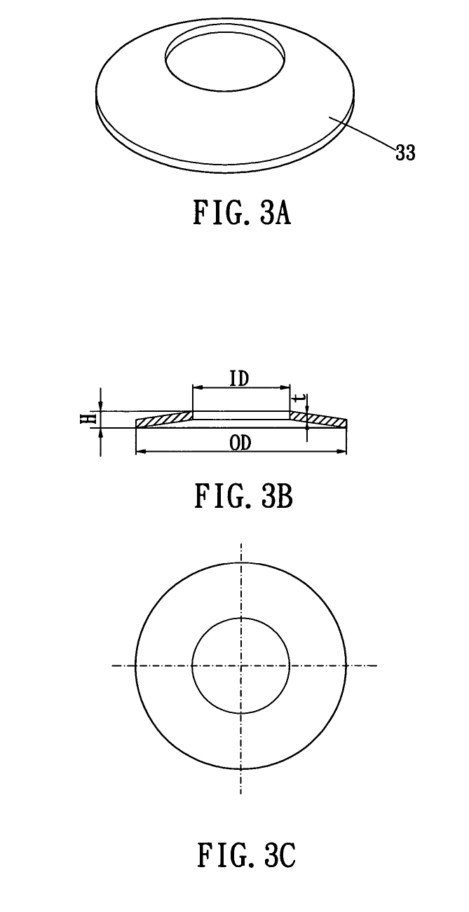

FIG. 2 is a perspective view of said hinge 30 applied in the rotary loudspeaker of the invention. There is a rotating center-axle (A). A least a Belleville spring 33 is installed on said rotating center-axle (A) for providing a suitable torsion and controlling the duration of said hinge 30. Said Belleville spring, as shown in FIGS. 3A and 3C, is a thin cone-like member having a central hole similar to a spacer. Said Belleville spring generates a large resilient force or resilient ratio on the axial-direction as FIG. 3B shown. By means of ratio change of the cone height (H) to the thickness (t) to get is different Loading-Deflection characters of said Belleville spring. By stacking an amount of such springs in the same or reversed direction can enlarge the load capacity. In addition, the outer diameter and inner diameter of said Belleville spring 33 are indicated by OD and ID.

Therefore, as shown in FIG. 2, by being applied with a suitable amount of Belleville springs on said rotating center-axle (A), said hinge 30 linking said loudspeaker 20 and said display 10 is maintained with a suitable torsion so as to keep said hinge 30 revolvable and stay at any required position and durable for a long time use. The adjustment lets said loudspeaker 20 stay at any suitable position and provide better sound effects.

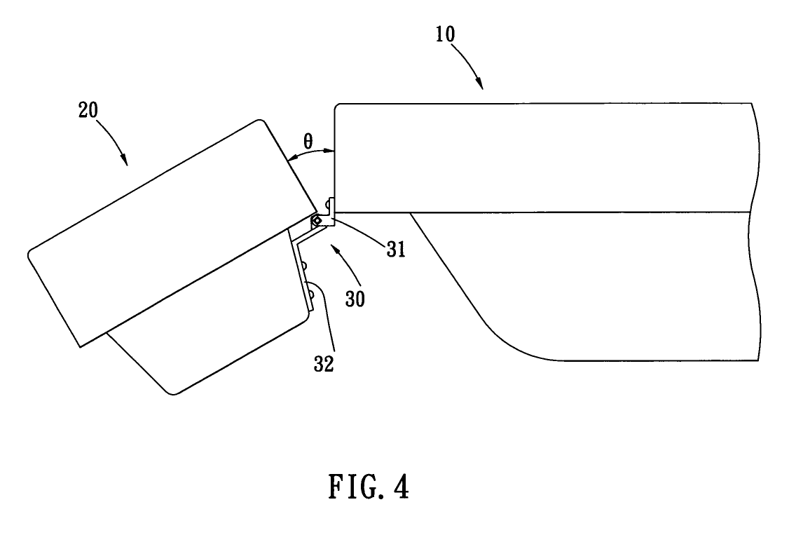

As shown in FIG. 1 and FIG. 4, the embodiment of main components said display 10, said loudspeaker 20, and said hinge 30. To complete said components as a whole, said first member 31 of said hinge 30 connects with a side of said display 10; at least one attachable loudspeaker 20 connects with said second member 32 of said hinge 30; said display 10 connects with at least one attachable loudspeaker 20. In FIG. 4, said loudspeaker 20 is rotated backward with an angle θ relative to said display 10. The rotation angle is changeable by user according to user's favorites of sound effects.

### Second Embodiment

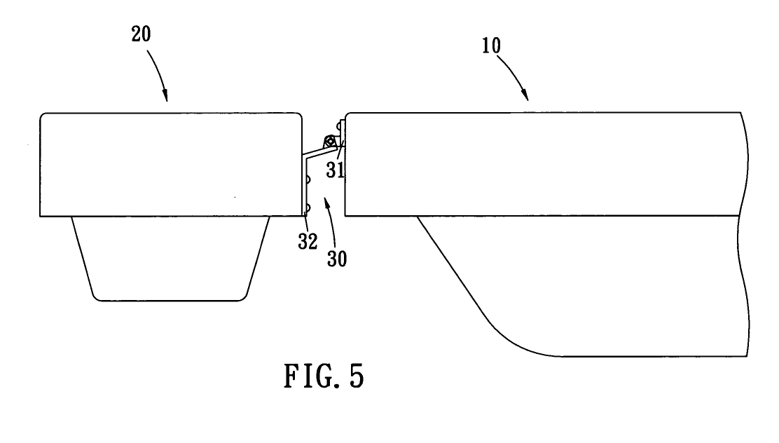

1. FIG. 5 shows a second embodiment of the invention. A loudspeaker rotary mechanism comprises a display 10, at least an attachable loudspeaker 20, and a rotary mechanism. Said rotary mechanism is a hinge 30 which composed of two members 31 and 32. Said first member 31 with an axle and said second member 32 without an axle. Said first member 31 connects with a side of said display 10 and said second member 32 connects with a side of said attachable loudspeaker 20. Said hinge 30 links said loudspeaker 20 to said display 10 in a manner that said loudspeaker 20 can be rotated relatively to said display 10.

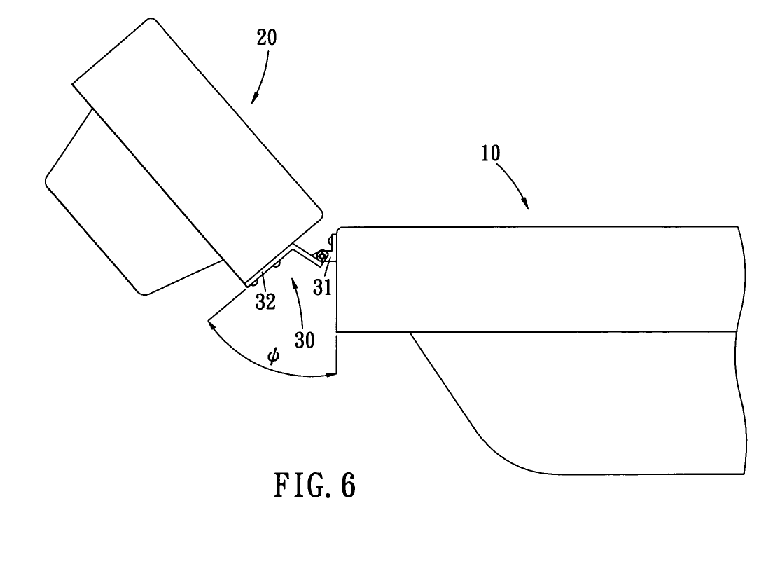

In FIG. 6, said loudspeaker 20 is rotated forward with an angle 4) from said display 10. Said rotation angle is changeable by user according to user's favorites of sound effects.

To achieve the best surrounding effect, the user can add multiple loudspeakers (such as heavy bass or high bass speakers) on both sides of the display and adjust angles of the loudspeakers. In other words, the number of loudspeakers is not limited. In addition, to be more convenience for users, a fixing pin (not shown in the drawing) can be formed on said hinge 30. Said fixing pin can let user fast adjust said rotation angle in certain angles.

The display in the aforesaid embodiment is a plasma television, an LCD TV, or other displays.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A loudspeaker rotary mechanism applicable to a display, comprising:
a hinge, including a first member with an axle and a second member without an axle; said first member connects with a side of said display; and
at least one loudspeaker, having a side connecting with said second member.

2. A loudspeaker rotary mechanism according to claim 1 wherein said display is a plasma television.

3. A loudspeaker rotary mechanism according to claim 1 wherein said display is an LCD television.

4. A loudspeaker rotary mechanism according to claim 1 wherein said first member of said hinge comprises a rotating center-axle.

5. A loudspeaker rotary mechanism according to claim 1 wherein said loudspeaker is rotated backward with a θ angle relative to said display.

6. A loudspeaker rotary mechanism according to claim 1 wherein said loudspeaker is rotated forward with a ψ angle relative to said display.

7. A loudspeaker rotary mechanism according to claim 4 wherein said rotating center-axle of said hinge is loaded with a plurality of Belleville springs.

8. A loudspeaker rotary mechanism according to claim 1 wherein said hinge further comprising of a fixing pin for adjusting said rotation angle of said loudspeaker to specific angles.
